(19) United States
(12) Patent Application Publication
(10) Pub. No.: US 2012/0231249 A1
(43) Pub. Date: Sep. 13, 2012

(54) CAR-SEAT SPLIT CRUST LEATHER AND METHOD FOR MANUFACTURING THE SAME, AND CAR-SEAT LEATHER USING THE CAR-SEAT SPLIT CRUST LEATHER AND METHOD FOR MANUFACTURING THE SAME

(75) Inventors: Mitsuru Fukukawa, Yamagata City (JP); Yoshihiro Abe, Yamagata City (JP); Shinji Kashiwagura, Nishimurayama-gun (JP)

(73) Assignee: MIDORI HOKUYO CO., LTD., Yamagata City, Yamagata (JP)

(21) Appl. No.: 13/510,789

(22) PCT Filed: Nov. 19, 2009
(86) PCT No.: PCT/JP2010/006812

§ 371 Date: May 18, 2012

(30) Foreign Application Priority Data
Nov. 19, 2009 (JP) 2009-263990

(51) Int. Cl. B32B 7/02; B05D 7/12; C14C 13/00; C14B 1/18; C14B 1/46

(52) U.S. Cl. 428/213; 69/21.5; 69/21; 8/436; 427/412

(57) ABSTRACT

Provided are a car-seat split crust leather and leather. A hide already subjected to pretreatment and subjected to tanning treatment is split into leather including a grain surface and into split leather with a thickness of 4 mm to 2.3 mm, the taken-out split leather is arranged so that a flesh side of the split leather can be located on an upper side and that a grain side of the split leather can be located on a lower side, split leather with a thickness of 2.6 mm to 1.8 mm is made, next, the flesh side of the split leather is shaved to thereby set the thickness of the split leather to 2.0 mm to 1.1 mm, and a car-seat split crust leather with a thickness of 1.6 mm to 1.0 mm is manufactured, which is then subjected to tanning and re-tanning treatment, and has a coating film formed thereon.

### TECHNICAL FIELD

The present invention relates to a car-seat split crust leather and to a method for manufacturing the same, and to car-seat leather using the car-seat split crust leather and to a method for manufacturing the same.

### BACKGROUND ART

From ancient times, natural leather has been used for tools, which are used in industry and life, by making use of excellent material characteristics thereof. The natural leather is manufactured by using a raw hide as a raw material. In a cowhide and the like, there are a hide (a thick and heavy hide like an adult cow hide with a unit weight of 25 pounds or more) and a skin (a thin, small and light skin like a calf skin). In the skin, there are such a calf skin (a skin of a calf within six months after birth) and a kip skin (a skin of a young calf within a range from six months to two years after birth).

The raw hide is manufactured into easy-to-use leather through a series of steps, in which fleshing treatment (removal of a subcutaneous tissue, a lump of flesh, fat and the like, which are attached onto a back surface), liming treatment (unhairing, removal of residuals such as hair roots, fat and scurf) and the like are performed as pretreatment steps, thereafter, tanning is performed, then re-tanning, dyeing and oiling are performed, and then a coating film is formed on a surface after drying treatment is performed as finishing treatment. Leather products are manufacturing by processing the manufactured leather. Onto the leather products, new requirements for leather are imposed in response to purposes, and positive researches and developments have been advanced in order to manufacture such leather.

In manufacturing car-seat leather by the natural leather, there are performed: pretreatment for performing the tanning; and the tanning by a tanning agent. The raw hide is composed of two layers. A surface layer as a region on which hair grows is referred to as a grain side layer, and an inside region on which flesh is present is referred to as a flesh side. The grain side layer is processed as leather widely used for car seats nowadays (also referred to as grain leather), and the flesh side is used as chamois leather used in a low-to-middle price range in general, and as a PU coating product in which polyurethane is adhered onto a surface.

Next, treatment by the tanning agent and treatment by the dyeing step and the oiling step are performed, and drying treatment is performed as the finishing treatment, and on the grain side layer (grain leather) as a surface of the leather thus obtained, a coating layer is formed. As a result, in recent years, car-seat leather has been able to be manufactured, which endures a severe usage environment and has fastness, softness and a good touch feeling even in the event of use for a long period. This car-seat leather is used as a facing material to face therewith a surface of a form frame that maintains a form. In such a way, an entire form of the car seat is expressed, which appeals to the five senses such as a comfort to sit on, a color, and a touch feeling, and in addition, durability of the surface is enhanced. Moreover, the car-seat leather exerts characteristics intrinsic to the leather, and overwhelms artificial leather, synthetic leather and the like, which replace the natural leather, in terms of flexibility, strength and a massive feeling, which are inherent in the leather.

In consideration of diversification of a sense of values for the car seat product thus obtained, attention has been paid to development of a car-seat split crust leather that does not use the grain side layer described above but uses split leather ranked lower than the grain side layer. Based on this matter taken as a background, the inventors of the present invention have decided to develop car-seat leather using the split leather.

The split leather is leather obtained by tanning a residual portion after the grain side layer is skived and separated. As a whole including a surface, conditions of a tissue and surface of the split leather are rough, and the tough feeling, gloss and color tone of the surface concerned are not sufficient even at a stage of the finishing since the grain side is removed. The split leather has heretofore been regarded as inferior in appearance to such full grain leather. Practical application of the split leather has been advanced in the fields of industrial gloves, quarters of shoes, and pouches, where the foregoing problems do not appear to the outside.

Split leather subjected to resin coating and embossing can be approximated to the full grain leather, and has a course to be used for manufacturing bags, shoe upper leather, and the like.

As a car component using the split leather, split leather for a steering wheel has already been practically applied. The split leather for a steering wheel is manufactured by performing pretreatment for the split leather and by being subjected to a tanning step, a re-tanning step, and then to a finishing step of performing drying and coating. Leather for a steering wheel has a small area, and accordingly, is not severely required to reduce weight thereof per unit area, and is manufactured somewhat thick in order to obtain sufficient tearing strength. Hence, even if the split leather for a steering wheel is used for car leather, it cannot be said that the split leather is sufficient in terms of the weight per unit area and softness.

In the event of manufacturing the car-seat leather from the split leather, even if the car seat using the split leather is manufactured directly following the conventional manufacturing method of the grain leather using the grain side layer, a car seat with satisfactory performance cannot be manufactured. Such contrivance becomes necessary as to how to process the split lather, how to manufacture the car-seat split crust leather, and how to manufacture the car-seat leather therefrom.

In the split leather, thick fibers with a high density are entangled with one another, and accordingly, it becomes necessary for the split leather to overcome the following points:

(1) A point that, in a surface skin of the split leather, surface characteristics such as smoothness are not sufficient; (2) a point that the weight per unit area is heavy; and (3) a point that the obtained leather is hard and is less likely to be stretched.

Next, conventional examples of the car leather are viewed, where a car-seat split crust leather is manufactured from split leather, and car-seat leather is manufactured from the car-seat split crust leather.

(2) Example of improving the leather tanning step (treatment included by a silica-based inorganic product in a colloid suspension state)

There is a leather tanning method for achieving a leather shrinkage temperature as high as 80° C. (PTL 1: Japanese Patent No. 3834064). The leather tanning method includes the steps of; removing alkaline substances such as fat lime, which is contained in grain leather, by neutralization using acid during an operation called deliming; subjecting split leather to a pickling function for a purpose of enabling softening thereof; and implementing two-stage tanning operations for the split leather, wherein the tanning operations include: a pre-tanning stage performed before an already-known shaving operation; and a tanning stage performed before the already known shaving operation, at least the pre-tanning stage is composed of an action to subject the pickled split leather or the delimed grain leather to a chemical function of a mixture with a base of aldehydes, of tannin and/or of acrylic resins, the mixture being free from chromium sulfate, and the mixture further contains a silica-based inorganic product in a colloid suspension state.

(3) There is known a method (PTL 2: U.S. Pat. No. 4,060,384) of obtaining a tanning-treated body by performing chromium treatment for the tanning-treated body, wherein, in an event of hide treatment, chromium is not used in a pre-tanning step, and a shrinkage temperature is set at 170° F. to 185° F.
(4) Method of treating a butt surface by thinning the same

The following method is known (PTL 3: Japanese Patent Laid-Open Publication No. H05-255700 (published in 1993)): “A method for manufacturing split leather, in which an immersed animal skin, in particular, a cowhide is split into a surface piece and a flesh side piece, the flesh side piece is separated into a butt, a neck portion and a flank portion; and the butt is thereafter immersed, tanned, chromium-tanned, applied with oil, dried, and finished, wherein, between such chromium-tanning and such oil application, the butt serving as a subject is first thinned to a thickness of 1.1 to 2.5 mm by shaving a split surface and a flesh side, and is tanned one more time, the split surface of the dried butt is finished, thereafter, an intermediate piece with a thickness of 0.5 to 1.0 mm is formed from this butt by shaving the flesh side, and subsequently, a flesh side of this intermediate piece is finished.”

The above describes the method for manufacturing split leather, in which the butt is tanned by using chromium, applied with oil, dried, and fined. Although there is a description that the split leather is for cars, this is not an invention directly related to the performance of the car-seat leather.

(5) Method of treating a raw hide portion by notching the same from a back side

In a preparation step, a raw hide portion in which collagen fibers are densely entangled with one another is notched from a back surface side, whereby a surface area of the notched portion is increased. Accordingly, in the event of treatment using alkaline, an agent such as lime milk comes to rapidly penetrate into a depth, and a difference in a treatment time using alkaline can be reduced between such a notched portion and other portions.

Therefore, in the case of using, for example, the cowhide in which there is not a large difference in hardness between the butt portion and other portions, and the like, the butt portion is notched, whereby, even if the treatment using alkaline is evenly performed for the respective portions, such intertwining of the collagen fibers can be disentangled substantially uniformly. Hence, in the tanning step, a tanning agent comes to be effectively coupled to the collagen fibers, and substantially uniform tanning can be performed (PTL 4: Japanese Patent Laid-Open Publication No. H08-73900 (published in 1996)). Making such notches is performed for the purpose of clarifying that the uniform tanning treatment is performed.

(6) There is a method of eliminating an influence to a leather surface of split leather from irregularities of the split leather by providing a synthetic resin buffer layer between such a surface of the split leather and a urethane-based resin skin through adhesive layers, thereby improving an exterior appearance of the split leather (PTL 5: Japanese Patent Laid-Open Publication No. H05-345384 (published in 1993); PTL 6: Japanese Patent Laid-Open Publication No. H08-35000 (published in 1996); and PTL 7: Japanese Patent Laid-Open Publication No. H07-242900 (published in 1995)). In the same way, there is a method of forming a foamed layer (PTL 8: Japanese Patent Laid-Open Publication No. H09-241700 (published in 1997)).

There is known a method (PTL 9: Japanese Patent Laid-Open Publication No. H08-81700 (published in 1996)) comprising the steps of: molding a polycarbonate-based polyurethane coating film with a film thickness of 10 to 60 μm, on a surface of which a crimp pattern is provided; adhering a surface of leather on a back surface of this polycarbonate-based polyurethane coating film, and forming a skin material; and implementing a milling process for the skin material, and developing ripples on the coating film of the skin material.

(7) Regarding an invention (PTL 10: United States Published Application No. 2008/0299406 A1) relating to manufacture of car leather from split leather

Features of this invention are as follows:

(a) Heretofore, a splitting step has been provided after a tanning step, and a thick hide attached with an unsplit grain side has been treated. The grain side has been avoided being tanned in a state of being attached with split leather. Accordingly, in consideration that an operation such as tanning can be treated as appropriate by obtaining a thin pelt, this invention is characterized in that, at a stage after a pretreatment step and before entering the tanning step, a splitting operation of separating, from a flesh side, the grain side so that the grain side can have a thickness of 2.5 mm to 4 mm is performed, and then there is performed a re-splitting operation of further splitting off, from the above, leather with a thickness of 1.8 to 2.5 mm from an upper surface of such a split layer (0036). It is presented that, in such a way, the tanning can be performed without any trouble (0038). After the re-splitting step, chromium tanning is performed (0041). In the above-described tanning step, such split leather is subjected to a deliming operation (0045), protein removal (0047), and a tanning operation fixing operation (0050). In a preliminary dyeing step after the tanning step, the split leather is shaved uniformly to a thickness of 1.2 to 1.4 mm in consideration of use of the split leather as a final product

(0061).

(b) The split leather is subjected to a tanning step (0065), is subjected to a second re-tanning step (0070), and is subjected to a drying step. Thereafter, water is applied to the split leather, and hardness and shrinkage thereof are eliminated (0078), and the split leather is sealed with a stucco agent. Thereafter, urethane resin, silica filler and pigment are sprayed onto a surface of the split leather already subjected to the tanning, and a coating film of a urethane resin layer is further formed on the surface (0080). Thereafter, the split leather is subjected to ironing in order to enhance physical properties thereof (0083). The above is features of this invention.

With regard to the item (a), even if the split leather with a thickness of 1.8 to 2.5 mm is attempted to be split off from the upper surface of the split layer after the splitting operation in the pretreatment of the tanning step, it is difficult to accurately obtain such a split layer with a thin thickness since a state is brought where an operator has difficulty grasping the pelt because the pelt is slippery. Originally, it is not appropriate to split off the split layer with a thin thickness at this stage. The split layer has variations in strength depending on regions thereof. Even if the split leather with a specific shape is manufactured while ignoring the variations, the portion in which the weight per unit area is heavy and the strength is low is not selected and cut off, such selection and cutoff being regarded necessary to solve the problems. Accordingly, it is pointed out, as a problem, that the split leather in which strength per unit weight is enhanced cannot be obtained.

With regard to the item (b), owing to the following reasons, the mention (0080) that the split leather is subjected to the ironing for the purpose of forming a smooth surface is not appropriate. In the event of forming the split leather, such split leather composed of thick and stiff fibers is processed without disentangling the fibers, and is further subjected to surface hardening and curing treatment. Indeed, the smooth surface can be formed; however, in the case of considering that a painting surface will be formed thereon, the split leather is formed to have a surface on which it is difficult to form a coating film. The method mentioned here is not appropriate, and is pointed out as a problem. Moreover, in this method, such treatment is not performed that a surface of split leather treated to be softened is smoothened and facilitated to form the coating film thereon. Accordingly, there cannot be avoided a result that the obtained leather becomes hard and less likely to be stretched.

From a viewpoint from the applicants of the present invention, the above-described invention discloses the method for manufacturing the split leather; however, does not mention performance and the like of the obtained product, and in addition, does not mention that the problems are solved.

(8) There is an invention (PTL 11: Japanese Patent Laid-Open Publication No. H10-195500 (published in 1998)). The invention relates to a composition for manufacturing leather or a pelt, wherein the composition contains: (a) a re-tanning agent; (b) fat liquoring oil; and (c) other additives according to requests, and the composition exists in such a form to give a homogeneous mixture at a time of being added to water of which amount is at least eight times an amount of the composition at a temperature of 10 to 60° C. In the invention, as the re-tanning agent, there is mentioned a vegetable tannin agent, an aromatic synthetic tannin agent, a resin tanning agent, a reactive tanning agent, or an inorganic tanning agent or a polymer tanning agent. This invention describes that the leather is specifically treated; however, does not describe a result when such an agent is used for the pelt.

From a viewpoint of the applicants of the present invention, the above-described invention discloses the method for manufacturing the split leather; however, does not mention the performance and the like of the obtained product, and in addition, does not mention that the problems are solved.

When the conventional examples are viewed, it is understood that the following problems are not solved for the split leather for use in the car-seat leather:

(1) The weight per unit area is heavy; (2) as the split leather, surface characteristics of the surface skin, such as smoothness, are not sufficient; and (3) the obtained leather is hard and less likely to be stretched.

### CITATION LIST

### Patent Literature

[PTL 1] Japanese Patent No. 3834064
[PTL 2] U.S. Pat. No. 4,060,384
[PTL 3] U.S. Pat. No. 5,269,814, Japanese Patent Laid-Open Publication No. H05-255700 (published in 1993)
[PTL 4] Japanese Patent Laid-Open Publication No. H08-73900 (published in 1996)
[PTL 5] Japanese Patent Laid-Open Publication No. H05-345384 (published in 1993)
[PTL 6] Japanese Patent Laid-Open Publication No. H08-35000 (published in 1996)
[PTL 7] Japanese Patent Laid-Open Publication No. H07-242900 (published in 1995)
[PTL 8] Japanese Patent Laid-Open Publication No. H09-241700 (published in 1997)
[PTL 9] Japanese Patent Laid-Open Publication No. H08-81700 (published in 1996)
[PTL 10] United States Published Application No. 2008/0299406 A1
[PTL 11] Japanese Patent Laid-Open Publication No. H10-195500 (published in 1998)

### SUMMARY OF INVENTION

### Technical Problem

A first subject which the present invention attempts to solve is to solve the following points in order to use the split leather for the car seat. Specifically, in the split leather, the thick and highly dense fibers are entangled with one another, and accordingly, in order to use the split leather as the car-seat split crust leather and the car-seat leather, the following problems should be solved, which are: (1) the weight per unit area is heavy; (2) as the split leather, the surface characteristics of the surface skin, such as smoothness, are not sufficient; and (3) the obtained leather is hard and less likely to be stretched.

A second subject which the present invention attempts to solve is to provide novel car-seat leather by using novel split leather capable of overcoming the foregoing problems and actually usable departing from the split leather, and to provide a method for manufacturing the novel car-seat leather.

### Solution to Problem

The inventors of the present invention have made researches on the foregoing subjects, and have found out that the foregoing subjects can be solved by examining individual operation contents and operation conditions in all of steps, which are the pretreatment, the tanning step, and the finishing step composed of the re-tanning/dyeing step/oiling step, the drying step and the coating step, and by adopting novel means.

(1) Solving means for the fact that the weight per unit area is heavy

In the case of using the split leather, the splitting operation is performed, which is to split the raw hide (pelt) into a grain layer (a hide portion including a grain side) as an upper portion and a split layer (a hide portion turning to the split leather). The split layer is thick, and in the case of using the split layer for the seat, re-splitting is required, which is to further thin the split layer. The split layer varies in strength depending on regions thereof. In response to the strength, there are portions to be left and portions to be cut off. It is necessary to determine these portions as appropriate.

Moreover, it is necessary to perform this treatment in a step where it is easy to slice and split the split layer by slicing. In the present invention, this treatment is performed at a stage after passing through a tanning preparation step and a tanning step. In PTL 10 that describes one of the conventional methods, in order to implement the tanning step for only the split layer, it is necessary to take out the split layer in advance, and therefore, the split layer is taken out before the tanning step. In a series of the operations, the drying step in the finishing step is ended after passing through “the treatment performed after the stage of the pretreatment before performing the tanning step is ended and before entering the tanning step, followed by the tanning step and the re-tanning/the dyeing step/oiling step, which are performed for the portion of the split leather”. In this case, in order to implement the tanning step for the split layer (the hide portion turning to the split leather), the re-splitting operation is performed for the split layer, followed by the tanning step. The hide introduced to the tanning step is tanned, and accordingly, this is considered to be rational since a usage amount of agents is small. In this case, the operation of splitting the hide into the grain layer as the upper portion and the split layer is not stabilized. The hide portion turning to the split leather with a specific thickness is slippery in the event of being grasped and taken out, and it becomes difficult to accurately perform such a slicing operation. It is rather impossible to accurately perform the splitting under such conditions. This splitting operation is difficult.

The inventors of the present invention have found out that, when a moment of performing this splitting is “set after the pretreatment is ended and leather subjected to the tanning treatment is manufactured by using a chromium compound as a tanning agent”, the operations are performed with ease, and a state can be brought where it is easy to slice the leather to a desired thickness.

Next, the split lather itself is thick, and accordingly, by thinning the same, reduction of the weight per unit area can be achieved. In the case of performing such weight reduction, it becomes necessary to leave strong portions in the split leather, and to thin weak portions therein. In the event of leaving the strong portions of the split leather, the inventors of the present invention have found out that, in the split leather, strength on the flesh side thereof is high, and strength on the grain side thereof is low.

At first, the surface on the grain side is sliced to be somewhat thick by a band knife, and next, the flesh side of the split leather is shaved to be somewhat thin by shaving, whereby the weight reduction can be achieved.

As a result, by using the band knife machine, the hide is split into the leather including the grain side and into the split leather with a thickness of 4 mm to 2.3 mm. The taken-out split leather is arranged so that the flesh side thereof can be located on an upper side and that the grain side thereof can be located on a lower side. At first, the surface on the grain side is sliced by the band knife to make split leather with a thickness of 2.6 mm to 1.6 mm, and next, the flesh side of the split leather is shaved by a shaving machine to thereby set the thickness of the split leather to a thickness of 2.0 mm to 1.1 mm. Subsequently, the grain side is shaved by the shaving machine. In such a way, split leather with a thickness of 1.6 mm to 1.0 mm is formed (FIG. 1 shows a state where the split leather is sliced). Split leather with a suitable shape can be left as the split leather. The subsequent operations on and after the re-tanning are performed, whereby it becomes possible to obtain split leather in which the surface skin is smooth.

(2) Countermeasures against the fact that, as the split leather, the surface characteristics of the surface skin, such as smoothness, are not sufficient

(a) In the re-tanning step, a re-tanning agent composed of vegetable tannin and synthetic tannin is used for the re-tanning. Among them, the vegetable tannin has a function to fill gaps among the fibers, and has an effect for smoothing of the surface. Moreover, the plan tannin has functions to suppress a stretch of a portion likely to be stretched, such as a belly portion in particular, and to suppress orange peel. The orange peel is a phenomenon that irregularities as on an orange appear on a surface of the leather when the leather is stretched, and is intrinsic to the split leather. The inventors of the present invention have found out that a relatively smooth plane can be obtained while avoiding a roughened state thereof.

(b) Regarding smoothing treatment for split leather

It is effective to perform smoothing treatment for the split leather before forming the coating film on the surface of the split leather. In the case of considering that the coating film is formed on the surface of the split leather, the split leather is not sufficiently smooth. In general, a roller is applied to the surface of the split leather after being applied with resin and the like, whereby a plane surface can be formed. However, such simple application of the roller is not sufficient in terms of forming the coating film.

The inventors of the present invention have devised that, before the coating film is formed on the surface of the split leather, a stucco agent is applied thereto, and thereafter, the surface of the split leather is buffed (filed), whereby the surface concerned can be turned to a flat state, and a state can be brought where the surface is fluffed. The stucco agent is aqueous urethane-based resin, and plays a role as filler. The stucco agent penetrates to a surface layer of the leather to fill the gaps among the fibers, and in addition, is fixedly attached to the surface. The surface is smoothed by subsequent buffing. In the case where an amount of the applied stucco agent is not sufficient, the stucco agent is applied again, and the surface is buffed one more time.

By the application of the stucco agent, the gaps among the leather fibers are filled, and the surface is coated. By the buffing, protrusions of the surface are shaved off, and the surface becomes flat, and turns to a fluffed state. In the event of forming the coating film, a coating liquid comes to appropriately penetrate, and in addition, a contact area between the coating liquid and the fibers is increased, and accordingly, adhesive force of the coating film layer onto the leather surface is strengthened. Moreover, since the leather is not pressed, deterioration thereof in mold fitting can also be avoided. There does not occur such a problem either that the mold fitting becomes shallow in embossing (pressing) performed after a color coating layer is formed. Three coating films are formed on such a surface obtained by being treated as described above, whereby novel split leather, which has not been able to be obtained heretofore, can be obtained.

(3) Solving means for the problem, which is inherent in the split leather, that the obtained leather is hard and less likely to be stretched

(a) With regard to the point that the leather is hard, the inventors of the present invention have found out that a reason that the leather is hard is because the split leather itself is composed of the thick and stiff fibers, and that this point can be solved by disentangling the fibers by milling the same.

Before the milling, the drying treatment is performed. The inventors of the present invention have performed the milling and vibration after performing vacuum drying/hang drying as the drying treatment, or alternatively, have performed the milling after the hang drying, and then have performed toggling and the vibration, whereby the inventors of the present invention have succeeded in disentangling the thick and stiff fibers, which compose the split leather, by combining the milling with the drying step. After the drying treatment performed by the drying, the milling, the toggling and the vibration, the flesh side of the split leather is buffed (filed), and subsequently, the grain side of the split leather is shaved by the band knife to set the thickness thereof at 1.4 to 0.9 mm, whereby a target thickness of the split leather, which is not thick, can be decided.

(4) The above is the solving means of the above-mentioned three problems. In the respective steps in the manufacture of the car-seat split crust leather and the car leather, which begins from the pretreatment, the above-described solving means is incorporated. It is necessary that, in accordance with the description of the scope of claims, the present invention be understood as the respective manufacturing steps of the car-seat split crust leather and the car-seat leather, which begins form the pretreatment. The respective manufacturing steps are described as the scope of claims, which are mentioned below.
[1] A car-seat split crust leather, characterized in that a hide already subjected to pretreatment and subjected to tanning treatment by using a chromium compound as a tanning agent is split, by using a band knife machine, into leather including a grain surface and into split leather with a thickness of 4 mm to 2.3 mm, the taken-out split leather is arranged so that a flesh side of the split leather can be located on an upper side and that a grain side of the split leather can be located on a lower side, at first, a surface on the grain side is sliced by a band knife to make split leather with a thickness of 2.6 mm to 1.8 mm, next, the flesh side of the split leather is shaved by a shaving machine to thereby set the thickness of the split leather to 2.0 mm to 1.1 mm, and subsequently, the grain side is shaved by the shaving machine to thereby obtain split leather with a thickness of 1.6 mm to 1.0 mm.
[2] A car-seat split crust leather, characterized in that the car-seat split crust leather is obtained in such a manner that the car-seat split crust leather according to [1] is subjected to re-tanning by using a re-tanning agent composed of vegetable tannin and synthetic tannin, followed by dyeing and oiling.
[3] A car-seat split leather, characterized in that the car-seat split crust leather according to [1] is subjected to drying treatment by performing vibration after performing vacuum drying/hang drying/milling, thereafter, the grain side of the split leather is shaved by the band knife to set the thickness of the split leather to 1.4 mm to 0.9 mm.
[4] A car-seat split crust leather, characterized in that the car-seat split crust leather according to [2] is subjected to drying treatment by performing hang drying, milling, toggling and vibration, thereafter, the grain side of the split leather is shaved by the band knife to set the thickness of the split leather to 1.4 mm to 0.9 mm.
[5] A car-seat split crust leather, characterized in that a stucco agent is applied on a surface of the car-seat split crust leather according to either one of [3] and [4], thereafter, the surface is buffed, and split leather with a smooth surface is formed.
[6] A car-seat split crust leather, characterized in that the stucco agent is applied again on the surface of the car-seat split crust leather according to [5], thereafter, the surface is buffed, and split leather with a smooth surface is formed.
[7] The car-seat split crust leather according to either one of [5] and [6], characterized in that the stucco agent is composed of: 100 to 150 weight parts of a urethane resin binder; 100 weight parts of a mixture formed of silica filler and pigment in a weight ratio of 1:1; and 700 to 800 weight parts of a water-soluble substance.
[8] Car-seat leather, characterized in that a base coat layer containing polyurethane resin, a color coat layer and a top coat layer are provided on the surface of the car-seat split crust leather according to either one of [5] and [6].
[9] Car-seat leather, characterized in that a hide already subjected to pretreatment and subjected to tanning treatment by using a chromium compound as a tanning agent is split, by using a band knife machine, into leather including a grain surface and into split leather with a thickness of 4 mm to 2.3 mm, the taken-out split leather is arranged so that a flesh side of the split leather can be located on an upper side and that a grain side of the split leather can be located on a lower side, at first, a surface on the grain side is sliced by a band knife to make split leather with a thickness of 2.6 mm to 1.8 mm, next, the flesh side of the split leather is shaved by a shaving machine to thereby set the thickness of the split leather to 2.0 mm to 1.1 mm, subsequently, the grain side is shaved by the shaving machine to thereby obtain split leather with a thickness of 1.6 mm to 1.0 mm, the split leather is subjected to re-tanning by using a tanning agent made of vegetable tannin and synthetic tannin, followed by dyeing and oiling, and is thereafter subjected to drying treatment of performing vibration after performing vacuum drying/hang drying/milling, or of performing the hang drying, the milling, toggling and the vibration, the grain side is skived by the band knife to set the thickness of the split leather to 1.4 mm to 0.9 mm, a surface of the skived leather split is applied with a stucco agent, and is buffed, whereby split leather with a smooth surface is obtained, and a base coat layer (film thickness: 30 to 40 μm) containing polyurethane resin, a color coat layer (film thickness: 10 to 15 μm) and a top coat layer (film thickness: 10 to 15 μm) are provided on the surface.
[10] Car-seat leather, characterized in that a thickness of a whole of the car leather, in which a coating film composed of a base coat layer containing polyurethane resin, a color coat layer and a top coat layer is formed on a surface of a car-seat split crust leather in which a thickness is 0.9 to 1.4 mm and a surface is applied with a stucco agent and smoothed, is 0.9 to 1.5 mm.

### Advantageous Effects of Invention

(1) In accordance with the present invention, the problems inherent in the car-seat split crust leather are solved, which are: (1) the weight per unit area is heavy; (2) as the split leather, the surface characteristics such as the smoothness of the surface skin are not sufficient; and (3) the obtained leather is less likely to be stretched.
(2) The car-seat split crust leather can be obtained, in which a hide having passed through a stage in which pretreatment of a tanning step is ended and having subjected to tanning treatment by using a tanning agent is split, by using a band knife machine, into leather including a grain surface and into split leather with a thickness of 4 mm or less to exceeding 2.3 mm, the taken-out split leather is arranged so that a flesh side of the split leather can be located on an upper side and that a grain side of the split leather can be located on a lower side, at first, a surface on the grain side is sliced by a band knife to make split leather with a thickness of 2.6 mm to 1.8 mm, next, the flesh side of the split leather is shaved by a shaving machine to thereby set the thickness of the split leather to 2.0 mm to 1.1 mm, subsequently, the grain side is shaved by the shaving machine, obtain split leather with a thickness of 1.6 mm to 1.0 mm is subjected to re-tanning by using a tanning agent composed of vegetable tannin and synthetic tannin, followed by dyeing and oiling, is subjected to drying treatment by performing vibration after performing vacuum drying/hang drying/milling or by performing the hang drying, the milling, toggling and the vibration, thereafter, the flesh side of the split leather is shaved by the band knife to set the thickness of the split leather to 1.4 mm to 0.9 mm, and a stucco agent is applied on the surface.
(3) Car-seat leather can be obtained, in which a thickness of a whole of the car leather, in which a coating film composed of a base coat layer containing polyurethane resin, a color coat layer and a top coat layer is formed on a surface of a car-seat split crust leather in which a thickness is 0.9 to 1.4 mm and a surface is applied with a stucco agent and smoothed, is 0.9 to 1.5 mm.

### BRIEF DESCRIPTION OF DRAWINGS

FIG. 1 is a view showing a state where split leather of the present invention is sliced.

FIG. 2 is a view showing a state where split leather of Patent Literature 10 is sliced.

FIG. 3 is a view showing a cantilever bending resistance tester.

FIG. 4 is a cross-sectional photograph of the split leather before application of stucco.

FIG. 5 is a cross-sectional photograph of the split leather after the application of stucco/drying/buffing.

FIG. 6 is a cross-sectional photograph of the split leather after formation of a coating film.

### REFERENCE SIGNS LIST

1: LEATHER TEST PIECE
2: SCALE BASE LINE
3: 45-DEGREE INCLINED SURFACE
A: PORTION INCLUDING GRAIN SIDE
B: SPLIT LEATHER PORTION WITH THICKNESS OF 4.0 mm TO 2.3 mm
C: SPLIT LEATHER PORTION WITH THICKNESS OF 2.6 mm TO 1.8 mm
D: SPLIT LEATHER PORTION WITH THICKNESS OF 2.0 mm TO 1.1 mm
E: SPLIT LEATHER PORTION WITH THICKNESS OF 1.6 mm TO 1.0 mm
a: PORTION INCLUDING GRAIN SIDE
b: SPLIT LEATHER PORTION WITH THICKNESS OF 4.0 mm TO 2.5 mm
c: SPLIT LEATHER PORTION WITH THICKNESS OF 1.8 mm TO 2.5 mm
d: SPLIT LEATHER PORTION WITH THICKNESS OF 1.2 mm TO 1.4 mm

### DESCRIPTION OF EMBODIMENTS

The present invention is split leather, car-seat leather using the split leather, and methods for manufacturing both of them. Each of the methods includes a long process that begins from a pretreatment step of tanning leather and reaches tanning, re-tanning/dyeing/oiling, a drying step in finishing, and formation of a coating film.

While mentioning a series of operations, a description is made of respective treatment steps.

The pretreatment (pretreatment (preparation operation) for performing tanning) is as follows.

A hide obtained by curing, in an appropriate state, a raw hide in a state of being left stripped from an animal can be turned to a conservable state for a long period. Such curing sets moisture of the raw hide at moisture at which microbes can grow or less.

Specifically, drying and salt curing and performed, and treatment by preservative is performed. A subcutaneous tissue, a lump of flesh, fat and the like are attached onto an inner surface of the raw hide. In order to remove these, fleshing is performed by using a fleshing machine.

Next, unhairing and liming are performed. The raw hide, which is allowed to absorb water and is softened, is immersed into lime milk, and a surface skin tissue is dissolved and removed. There are lime soaking to be performed after the liming, and blue splitting to be performed after chromium tanning. Heretofore, in this step, an operation of splitting the hide into a grain side leather portion and other portions has been performed. In the present invention, such splitting is not performed in this step, but is performed after tanning is ended. In the present invention, the splitting is not performed in this step, but pretreatment before the tanning is performed. The hide having such a grain side layer is subjected to neutralization by deliming, water is added thereto, calcium hydroxide is eluted therefrom by shrinkage, and the hide is subjected to bating treatment of performing enzyme treatment, and thereafter, is subjected to pickling treatment by acid. The pretreatment is ended after passing through the above-described respective steps.

Regarding Tanning Step

Tanning refers to treatment of irreversibly converting a raw hide into leather, which has a variety of practical performance, by chemical and physical operations. Objects of the tanning are: (1) to impart heat resistance to the leather (in a range of 90 to 110° C.); (2) to impart resistance to chemical reagents and microbes; and (3) to impart softness to the leather, and to impart unique quality as the leather itself thereto.

As a tanning agent, a chromium compound is used. As the chromium compound, a trivalent chromium complex, that is, violet hexaaqua crystal chromium sulfate expressed as Cr₂(SO₄)₃ is used. In usual, the tanning is performed under a condition where a concentration of the tanning agent is 0.2 M or more.

In the event of such chromium tanning, in order to prevent an occurrence of deposition of the insoluble chromium among collagen fibers of the hide already subjected to the preparation operation as the pretreatment, pickling treatment is performed by using acid (sulfuric acid is generally used; hydrochloric acid, formic acid and aromatic sulfonic acid are also used in some case) and salt (sodium chloride is generally used; sodium sulfate, calcium formate and sodium formate can be used). A chromium complex with a basicity of 0 does not exhibit tanning performance for the hide. When the basicity or pH rises, a size of the complex and holding electric charges thereof are increased. When the basicity rises more than a limit thereof, the complex is mutually coagulated and is deposited. It is necessary to advance the tanning while controlling the basicity.

The tanning is performed by a single bath process using such trivalent chromium tanning. A temperature of such a tanning agent in this case is 30 to 40° C. In a chromium solution with a basicity of 33%, a chromium absorption amount is increased owing to an increase of a concentration thereof, and becomes maximum when Cr₂O₃ is 50 g/l. The basicity is approximately 33% at the beginning, and thereafter rises to approximately 50%. The pH is approximately 3.4 to 3.8. As a masking agent, formate, sulfite and the like are used.

In the present invention, at a stage where the tanning step for the hide is ended, there is performed a splitting operation of splitting the raw hide (pelt) into a gray layer (leather portion including the grain side) as an upper portion of the hide and into a split layer (leather portion becoming split leather) as a lower portion thereof.

With regard to the split layer as the lower portion, an operation of leaving a strong portion and cutting a weak portion is repeatedly performed, whereby the strong portion can be finally left.

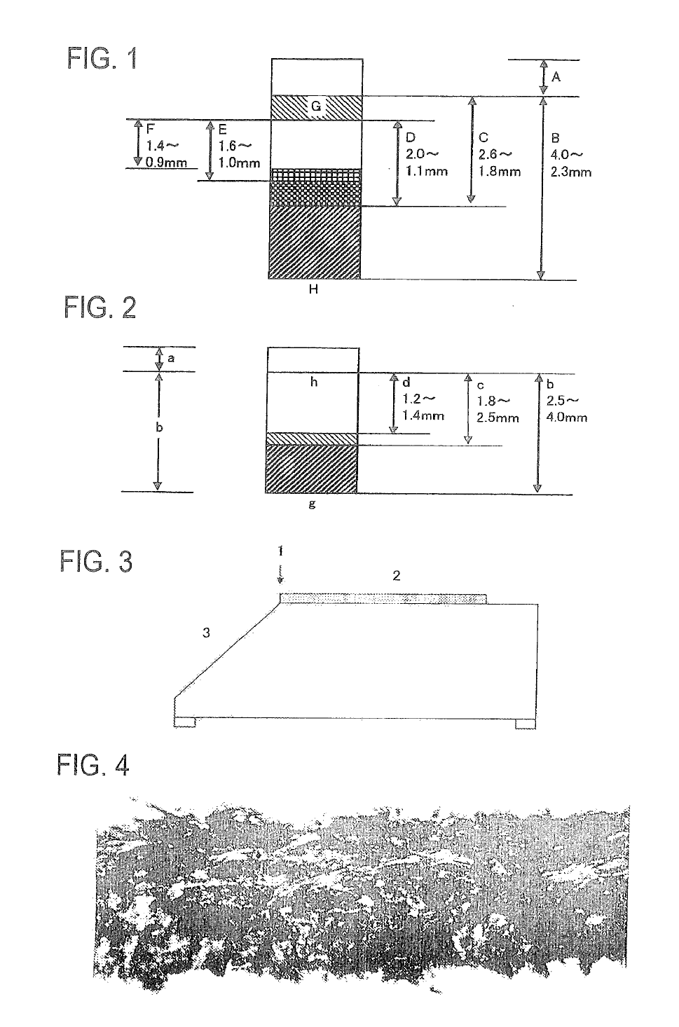

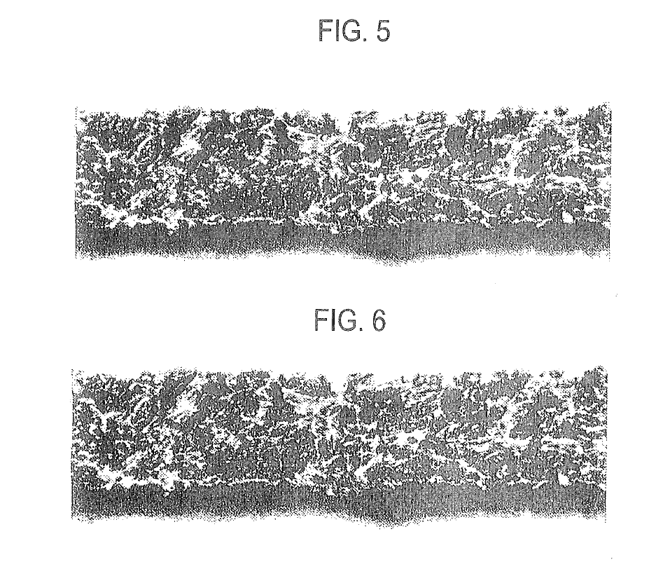

The above is further described by using FIG. 1. FIG. 1 is a view explaining contents of the present invention.

As a result of the above-described operation, the fact that weight per unit area is heavy is solved, and split leather serving as a base of split leather having surface characteristics such as smoothness of a surface skin can be obtained.

The leather, which is already subjected to the pretreatment of the tanning step and is subjected to the tanning treatment by using the chromium compound as the tanning agent, is split into leather (portion A) including the grain side and a split leather portion (B) with a thickness of 4 mm to 2.3 mm by using a band knife machine.

The taken-out split leather is arranged so that a flesh side (G) thereof can be located on an upper side and that such a grain side (H) thereof can be located on a lower side. At first, the surface on the grain side is sliced by the band knife to make split leather with a thickness of 2.6 mm to 1.8 mm (C), and next, the flesh side of the split leather is shaved by a shaving machine to be thereby set to a thickness of 2.0 mm to 1.1 mm (D), and subsequently, the grain side is shaved by the shaving machine to make split leather (E) with a thickness of 1.6 mm to 1.0 mm. Car-seat split leather is manufactured by using this. A state where the tanned leather is sliced is as shown in FIG. 1. Here, the leather is sliced as planned based on the fact that a good result is obtained when a region serving as the split leather is sliced in a state shown in this drawing.

This split leather is subjected to re-tanning by using a tanning agent composed of vegetable tannin and synthetic tannin, subsequently, is subjected to dyeing and oiling, and thereafter, is subjected to drying treatment of performing vibration after performing vacuum drying/hang drying/milling, or performing the hang drying, the milling, toggling and the vibration.

With regard to a point that the split leather is hard, the reason that the split leather is hard is because the split leather itself is composed of thick and stiff fibers, and it is effective to disentangle the fibers by milling the same. Before the milling, the drying treatment is performed. The inventors of the present invention have performed the milling and the vibration after performing vacuum drying/hang drying as the drying treatment, or alternatively, have performed the milling after the hang drying, and then have performed the toggling and the vibration, whereby the inventors of the present invention have succeeded in disentangling the thick and stiff fibers, which compose the split leather, by combining the milling with the drying step.

After performing the drying treatment performed by the drying, the milling, the toggling and the vibration, the flesh side of the split leather is buffed (filed), and subsequently, the grain side of the split leather is shaved by the band knife to set the thickness of the split leather at 1.4 to 0.9 mm, whereby a target thickness of the split leather, which is not thick, can be decided.

The reason that the flesh side of the split leather after the drying treatment is buffed is in order to uniform the thickness of the split leather after band knife treatment in the next step. At a stage after the drying treatment, the flesh side of the split leather, which serves as a reference surface of the band knife treatment, is subjected to the shaving treatment; however, protruding thick fibers are left to form protrusions, and if the band knife treatment is performed while the protrusions are being left, then variations occur in thickness. Accordingly, before the band knife treatment, the surface of the flesh side of the split leather, which serves as the reference surface, is buffed and smoothed, whereby the thickness of the split leather after the band knife treatment is uniformed.

For 25 pieces of half-cut split leather buffed after the band knife treatment (set thickness: 1.15 mm), thicknesses thereof were measured at five spots per each piece (125 spots in total). Then, an average thickness was 1.06 mm, a minimum thickness was 0.80 mm, a maximum thickness was 0.80 mm, a was equal to 0.093, and the thicknesses did not attain normal distribution. In a similar way, thicknesses of half-cut split leather buffed before the band knife treatment were measured. Then, an average thickness was 1.20 mm, a minimum thickness was 1.10 mm, a maximum thickness was 1.30 mm, c was equal to 0.063, and the thicknesses attained the normal distribution. A thickness of the split leather when the grain side is skived by the band knife is set at 1.4 mm to 0.9 mm (F).

A stucco agent was applied on the surface of the split leather, and the surface was buffed. The split leather was further sliced in the above-described range by a slicing method shown in FIG. 1. Moreover, the case of Patent Literature 10, which has been heretofore performed, is shown in FIG. 2.

In the case of FIG. 2, the hide is split into leather (portion a) including a grain side and a split leather portion (b) with a thickness exceeding 4.0 mm to 2.5 mm. Unlike the case of FIG. 1, in the case of FIG. 2, a flesh side is shaved to obtain a portion c (with a thickness of 1.8 to 2.5 mm), the flesh side g is next shaved in the same way, and a portion d (with a thickness 1.2 to 1.4 mm) is further obtained.

When FIG. 1 and FIG. 2 are compared with each other, it is understood that the flesh side is shaved more in FIG. 1. FIG. 2 shows that only the flesh side is used.

As a result, split leather can be obtained, which has surface characteristics: (1) that smoothness of the surface skin therein are not sufficient; (2) that the weight per unit area is heavy; and (3) that the obtained leather is hard and is less likely to be stretched.

In the case of shaving the flesh side by the shaving machine, a shaving thickness affects strength of the split leather. It has been found out that, in order to leave a strong portion without lowering the strength, it is important to suppress the shaving thickness for the flesh side to 1.00 mm or less, desirably 0.8±0.1 mm. In the case where the shaving is performed from the flesh side, and a shaving range is increased, for example, is 1.00 mm, then the split leather has tensile strength of 300 Nor more; however, the tensile strength is lowered to 300 N or less when the shaving thickness becomes 1.1 mm or more.

With regard to test pieces with a width of 30 mm and a length of 150 mm, tensile strength of each thereof at a time of tensile fracture was measured by a tensilon-type tensile tester (Shimadzu AG1, made by Shimadzu Corporation) when the test piece was pulled at a speed of 200 mm/min.

The shaving ranges (mm), the product thicknesses (mm) and the tensile strengths (N/30 mm) are as follows:

(I) Shaving range: 0.9 mm; product thickness: 1.0 mm; tensile strength (N/30 mm): average 451;
(II) Shaving range: 1.0 mm; product thickness: 1.0 mm; tensile strength (N/30 mm): average 357;
(III) Shaving range: 1.1 mm; product thickness: 1.0 mm; tensile strength (N/30 mm): average 252
It is understood that there is a difference of 200 in strength average thereamong.

The thinning itself of the thickness of the split leather has been heretofore known. In Patent Literature 10, the thinning is performed before the deliming operation, and accordingly, is performed in the pretreatment step. Meanwhile, the inventors of the present invention determine that it is difficult to thin the split leather to an appropriate thickness by the operation in the pretreatment, and decide to perform the thinning after the tanning step. The reason for the above is because the inventors have realized that, in Patent Literature 10, the split leather contains lime and becomes alkaline, and accordingly, is slippery and difficult to handle, and in addition, swells and is thickened, and it is extremely difficult to split the pelt at an accurate thickness.

After the splitting operation in the pretreatment of the tanning step, in the case of obtaining the split leather with a thickness of 1.8 to 2.5 mm from the split layer, it is difficult to grasp the split layer, and it is difficult to set a dimension of the split layer accurately to a thin dimension. It is not appropriate to make a setting to this dimension at this stage. The split layer has variations in strength depending on regions thereof. Even if the split leather with a specific shape is manufactured while ignoring the variations, the portion in which the weight per unit area is heavy and the strength is low is not cut off, such selection and cutoff being regarded necessary to solve the problems. Accordingly, the split leather in which strength per unit weight is enhanced cannot be obtained (FIG. 2 displays contents of the slicing).

In Patent Literature 3, between the chromium tanning and the oiling, the butt is first thinned to a thickness of 1.1 to 2.5, preferably 1.2 to 1.5 mm by shaving the split surface and the flesh side, then the re-tanning is performed, and the split surface of the dried butt is finished. Thereafter, the intermediate piece with a thickness of 0.5 to 1.0 mm, preferably 0.7 to 0.9 mm is formed from this butt by shaving the flesh side, and subsequently, the flesh side of the intermediate piece is also finished. The strength is not taken into consideration in a point of the slicing, and the split leather is sliced roughly. By means of such a way of the slicing, sufficient strength cannot be maintained.

In accordance with the present invention, the splitting is performed after the tanning step using chromium as the tanning agent. Accordingly, such a malfunction as caused when the splitting is performed in the pretreatment step does not occur.

In the present invention, the pelt is not split in the pretreatment step, and the pelt is tanned in a thick state. Accordingly, in comparison with the case of tanning the pelt in a thin state after the pelt is split, it is difficult for the tanning agent to penetrate into the pelt. In order to cope with this, recharge of chromium is performed in the re-tanning step, whereby a shortage of the tanning can be compensated, and as a result, a good result can be obtained in comparison with the conventional case.

The above-described operation of individually slicing both surfaces of the split leather by the band knife is enabled in such a manner that the inventors of the present invention have found out for the first time, based on experiences thereof, that “the strength of the grain side of the split leather is weaker than the strength of the flesh side of the split leather”.

In the present invention, the grain side is sliced by the band knife based on this fact, whereby the strength is maintained sufficiently.

Regarding Treatment Before Re-Tanning

Before performing the re-tanning, the dyeing step and the oiling step, the selection and the shaving (necessary operation in the manufacturing process of the leather) are performed. The shaving is an operation of adjusting the leather to a constant thickness in response to the product thickness taken as a target.

In the chromium-tanned leather, there are contained an uncombined tanning agent, excessive acid, and leather garbage. Moreover, it is necessary to adjust surface electric charges and the like of the leather before the re-tanning, the dyeing step and the oiling step. Furthermore, it is necessary to disentangle the tissue. In order to perform these, washing (water-washing) and neutralization are performed. pH of the leather after the chromium tanning is usually 3 to 4, the leather contains a large amount of acid, and electric charges thereof are extremely intense. Therefore, in this state, it is difficult for the chemical agents to sufficiently penetrate into the inside in the re-tanning, the dyeing step and the oiling step, and accordingly, it is necessary to neutralize the acid. For the neutralization, sodium hydrogen carbonate and sodium formate are used. As a pH buffering agent, synthetic tannin is used.

The-above described treatment operations are processed in the same drum.

Regarding Re-Tanning, Dying Step and Oiling Step

In the general manufacturing method of the chromium leather, steps up to the chromium tanning are advanced by relatively standardized operations, and thereafter, in the re-tanning, the dyeing and the oiling, there is performed treatment that corresponds to diversification corresponding to a type of the product and corresponds to a change of operation conditions, which is required following the diversification. Target points of the individual stages are to enhance values added to the product leather, for example, to enhance sensory quality such as a touch feeling and a gloss, and to impart special functionality (water proof). Accordingly, the treatment in the re-tanning, the dyeing and the oiling is concerned also with the finishing step.

As the re-tanning agent, there are known: (1) an inorganic tanning agent such as chromium, aluminum and zirconium; (2) vegetable tannin (wattle, quebracho, chestnut, mirbane, or the like); (3) a synthetic tannin agent (a formaldehyde condensation compound of aromatic sulfonic acid (mainly sulfonic acid of naphthalene and phenol), an amino compound and a formaldehyde condensate, a resin tanning agent obtained by containing other polymers in these, an aldehyde compound or the like); (4) a resin tanning agent; and (5) aldehyde.

In the present invention, for the re-tanning agent of the split leather, a re-tanning agent composed of the vegetable tannin and the synthetic tannin is employed. In the re-tanning of the car-seat split crust leather, use of the re-tanning agent composed of the vegetable tannin and the synthetic tannin has not been heretofore performed, and in the present invention, an effect intrinsic to use of the vegetable tannin can be obtained.

Contents of the above are as follows.

The above-described car-seat split crust leather is a car-seat split crust leather obtained by being subjected to the re-tanning by the re-tanning agent composed of the vegetable tannin and the synthetic tannin, and by subsequently being subjected to the dyeing and the oiling.

The method for manufacturing the car-seat split crust leather is as follows.

The method is a method for manufacturing a car-seat split crust leather, characterized in that the above-described car-seat split crust leather is subjected to the re-tanning by the re-tanning agent composed of the vegetable tannin and the synthetic tannin, and by subsequently being subjected to the dyeing and the oiling.

The reason that the re-tanning agent composed of the vegetable tannin and the synthetic tannin is selected for the manufacture of the car-seat split crust leather is because the vegetable tannin can make the split leather less likely to be stretched, and can make the orange peel less likely to appear. By using the vegetable tannin, the gaps among the leather fibers can be filled, and the surface of the split crust leather can be smoothened.

General features of the vegetable tannin are as follows.

(a) The vegetable tannin is weak-anionic.

(b) In molecules of the vegetable tannin, large numbers of carboxyl groups, hydroxyl groups and aromatic rings are present, and accordingly, a capability of a non-ionic bonding intermolecular interaction is high. Therefore, the molecules of the vegetable tannin aggregate to a greater or less extent, and form a colloid-like polydispersion body in which a distribution of particle sizes is wide. It is regarded that the molecules of the vegetable tannin have strong adsorptive activity. In particular, the vegetable tannin has strong reactivity with a cation body, and is widely used as the re-tanning agent of the chromium leather.

(c) The particle size and reactivity of the vegetable tannin is affected by a concentration thereof, a temperature and the like, and in addition, the function thereof is accelerated and suppressed depending on the presence of electrolytes, sugars, low-molecular polarity substances, and the like.

(d) It is regarded that chemical stability of the vegetable tannin is a little inferior.

The effects of using the re-tanning agent composed of the vegetable tannin and the synthetic tannin in the present invention are as follows.

It is recommended that the vegetable tannin is used in combination with the synthetic tannin in order to effectively use the vegetable tannin. The synthetic tannin has a function to accelerate the penetration and dispersion of the vegetable tannin into the leather. The synthetic tannin can be expected to play the role described above.

A ratio of the vegetable tannin and the synthetic tannin is (40 to 80 mass %): (60 to 20 mass %) (a total of both thereof is 100%).

The vegetable tannin is a tanning agent obtained from mimosa, quebracho, oak, chestnut, or bark of pine. The vegetable tannin contains pyrogallol or pyrocatechol.

The synthetic tannin is an aromatic synthetic tannin agent. The synthetic tannin is a compound obtained by condensing, with formaldehyde and/or urea, a sulfonated aromatic compound singly or together with other aromatic compounds which are unsulfonated in usual. Examples of the aromatic compound suitable for this purpose are naphthalene, biphenyl, terephenyl, phenol, cresol, 4,4′-dihydroxydiphenylsulfone, β-naphthol, dihydroxybenzene, resorcinol, 2,2-bis(hydroxyphenyl)propane, and diaryl ether, for example, diphenyl ether and ditryl ether (these themselves may be sulfonated by a publicly known method). The aromatic synthetic tannin agent is the following compounds: (I) a condensation product of sulfonated phenol or cresol and formaldehyde; (II) a condensation product of naphthalene sulfonic acid and formaldehyde; (III) a formaldehyde condensation product of 4,4′-dihydroxydiphenylsulfone, to which aryl sulfonic acid or (hydroxy)aryl sulfonic acid is added; (IV) a formaldehyde condensation product of a sulfone-containing aromatic hydroxyl compound, to which halogenated aralkyl is added; (V) a urea-formaldehyde condensation product of phenol and phenol sulfonic acid; (VI) a reaction product of phenol and a sulfonating agent, where a molar ratio of phenol:SO₃ is (1):(1.1 to 2.2); (VII) a condensation product of sulfonated diaryl ether and formaldehyde; (VIII) a condensation product of sulfonated biphenyl or ether phenyl and formaldehyde; (IX) a condensation product of 4,4′-dihydroxyphenylsulfone and sulfonated 4,4′-dihydroxyphenylsulfone and formaldehyde; (X) a formaldehyde condensation product of diaryl ether sulfonic acid and 4,4′-dihydroxydiphenylsulfone; and (XI) a formaldehyde condensation product of phenol, to which aryl sulfonic acid or hydroxyaryl sulfonic acid.

Moreover, in the present invention, as described above, the re-tanning is performed by using the re-tanning agent composed of the vegetable tannin and the synthetic tannin for the manufacture of the car-seat split crust leather. As a result, as an intrinsic effect obtained by using the vegetable tannin for the car-seat split crust leather, there is a function to fill the gaps among the fibers, leading to an intrinsic effect to smooth the surface of the split leather. Moreover, use of the re-tanning agent has functions to suppress a stretch of a portion likely to be stretched, such as a belly portion in particular, and to suppress the orange peel. The orange peel is a phenomenon that irregularities as on an orange appear on the surface of the leather when the leather is stretched, and is intrinsic to the split leather. By using the vegetable tannin, the points heretofore regarded as problems can be solved.

Dyeing Step

Leather dyeing is made based on an interaction between the leather fibers and the dye. As a result, some bonding occurs between the leather fibers and the dye, and practical fastness is generated. As the leather dye, (1) an acid dye is the most important dye. The acid dye has a sulfonic acid group or a carboxylic acid group as a water-soluble group of a dye residue (D), and exhibits anionic characteristics in an aqueous solution. As the acid dye, there are a level dyeing/penetration-type acid dye, a surface dyeing-type acid dye, and a metal complex salt dye. As other leather dyes, there are: (2) a direct dye; (3) a basic dye; (4) a reactive dye; (5) a sulfuration dye; (6) a vat dye; and the like.

Oiling Step

The chromium leather that covers the main field of the leather products is required to have softness to a greater or less extent.

It is not sufficient if the dried leather is only kneaded mechanically. For the leather, it is necessary to apply an appropriate oil agent called fat liquoring oil. In a state where the tanned leather gets wet with water, the softness of the fibers of the leather is held thanks to water present in fiber bundles and in the gaps among the fibers. When the leather is dried, the fibers are agglutinated to one another, and the fibers and the tissue are hardened.

In advance before the drying, the oil agent as such a substance that inhibits the agglutination is allowed to exist among the fibers. Then, the tissue is not hardened even if being dried. This is because the oil agent is substituted for water in the leather fibers. Moreover, when a layer of the oil agent exists among the dried fibers or on the surfaces of the dried fibers, then sliding among the fibers is improved, and the softness is imparted to the leather. An object of the oiling is to achieve a lubrication effect among the fibers, which is expected first. Besides, the oiling affects protection of the leather fibers, which relates to water repellency or water proof, the touch feeling, puffing and gloss of the leather.

As the fat liquoring oil, there are known: (1) anionic fat liquoring oil (sulfonated oil, sulfonation oil, bisulfonated oil, fatty acid soap, multipolar fat liquoring oil, and the like); (2) cationic fat liquoring oil; (3) amphoteric fat liquoring oil; (4) nonionic fat liquoring oil; and (5) neutral oil (animal oil, marine animal oil, vegetable oil, mineral oil, synthetic oil).

In the event of passing through the oiling step and proceeding to the next drying step, preferably, the leather is supplied through a water squeezing (setter) step. In such a way, the oiling step can be ended and the treatment can be allowed to proceed to the next drying step.

Finishing Preparation Step

The finishing preparation step is composed of the drying step and a coating step.

In a finishing preparation operation, there are operations which start from damp drying and reach flattening of the leather before the coating finishing.

After being subjected to the re-tanning, the neutralization, the dyeing and the oiling, the leather is subjected to horse up for 12 hours or more in order to fixedly attach the dye and the fat liquoring oil. Moisture of the leather at this time is approximately 70 to 80% though differs depending on the way of tanning, the neutralization/re-tanning and the like. It is necessary to flatten the leather and to smooth wrinkles of the surface of the leather, and operations for this are performed by a roll setter. After the water squeezing, the stretched leather contains moisture of approximately 50 to 60%, and is required to be further dried.

Drying means includes: (1) hang drying (This is performed at 5 to 50° C. The drying temperature is set higher and lower in response to a required product character. As a result of the drying, the leather is dried to moisture of 10 to 15%); (2) “glass-paste” drying (The leather, which is water-squeezed by a water squeezing machine, and is stretched according to needs, has the grain side thereof starched on a glass plate or an enameled steel plate, followed by drying. The drying is performed at a low temperature (40 to 50° C.), and adjusts the temperature subsequently to 50° C., finally to a lower temperature, and so on. A moisture content of the leather at a stage where the drying is ended is 10 to 20%); (3) vacuum drying (Extra water is squeezed at first to set the moisture content to approximately 55%, the leather is subjected to vacuum drying on a hot plate of a temperature of 70 to 80° C. for 3 to 4 minutes, and the moisture content of the leather is set to 25 to 30%. The leather is taken out, has the moisture thereof uniformed, and is subjected to staking in order to be softened. Then, the leather is dried again for 1 minute, and the moisture content is lowered to 16 to 18%. Moreover, such a method is adopted, in which the moisture content after the first vacuum drying is set to 35 to 40 weight %, and then the treatment proceeds to the hang drying, conditioning, staking, and “toggle-paste” drying); and (4) high frequency drying (The leather is passed through two plates electrically connected to a high frequency alternating current generator).

In the drying step, the following operations are adopted according to needs.

(a) Conditioning

The leather turns to a dry state for the first time after the steps advance in the damp state to the dyeing and the oiling. Accordingly, the character of the leather is also changed. Leather protein becomes poor in hydrophilicity, chromium complex salt as the tanning agent is stabilized, and as a whole of the leather, cationic properties are reduced. By the fact that the moisture is reduced from the leather, and that the leather is affected by a heat effect, the bonding of the added oil, the vegetable tannin and the like is strengthened. In a state of the hang drying, the surface of the leather is in a state of being prone to be broken, and has turned to an unnatural state since the leather is dried in a stage of being strongly stretched. The leather is left in a cool and dark place, and so on, is allowed to naturally take up moisture, and thereafter, is sprayed with water by the conditioning, and is set to an appropriate moisture state.

(b) Staking

The fiber tissue of the leather, in which the fibers are adhered and squared to one another owing to the drying, is pulled in various directions, whereby the staking is performed in order to disentangle the fibers of the leather, and to impart the softness and elasticity thereto.

(c) Toggling, Trimming

The hide originally wraps an animal body, and accordingly, has a shape formed by longitudinally cutting and opening a cylindrical shape. In order to form such a hide to flat plate-like leather, the fibers thereof are disentangled by the staking, and thereafter, the leather is pulled and stretched as appropriate at a stage where some moisture remains, and is pasted onto a net or a plate, followed by drying and fixing.

When the leather is pasted too strongly, the finished leather becomes a thin one poor in elasticity and puffing. When the leather is pasted loosely, then the leather is not fixed, the wrinkles remain, and a whole of the leather turns to a shrunk state, and becomes lack of flatness.

(d) Buff brushing (sandpaper application)

Buff brushing is employed in such cases of uniforming inner surfaces of glove leather, and of making suede.

In the present invention, a specific and new drying method is employed in order to obtain the car-seat split crust leather.

The car-seat split crust leather is subjected to the vacuum drying/hang drying/milling, and thereafter, is subjected to the drying treatment by performing the vibration therefor. Thereafter, the flesh side of the split leather is buffed (filed), and subsequently, the grain side of the split leather is stripped by the band knife to set the thickness of the split leather to 1.4 to 0.9 mm.

Alternatively, the car-seat split crust leather is subjected to the drying treatment by performing the hang drying, the milling, the toggling and the vibration therefor. Thereafter, the flesh side of the split leather is buffed (filed), and subsequently, the grain side of the split leather is stripped by the band knife to set the thickness of the split leather to 1.4 to 0.9 mm. In such a way, the target thickness of the split leather, which is not thick, can be decided.

No matter which method may be employed, the car-seat split crust leather will have a thickness ranging from 1.4 to 0.9 mm.

The reason that the flesh side of the split leather after the drying treatment is buffed is in order to uniform the thickness of the split leather after the band knife treatment in the next step. At the stage after the drying treatment, the flesh side of the split leather, which serves as the reference surface for the band knife treatment, is subjected to the shaving treatment; however, the disentangled and protruding thick fibers are left to form the protrusions, and if the band knife treatment is performed while the protrusions are being left, then the variations occur in thickness. Accordingly, before the band knife treatment, the surface of the flesh side of the split leather, which serves as the reference surface, is buffed and smoothed, whereby the thickness of the split leather after the band knife treatment is uniformed.

For 25 pieces of the half-cut split leather buffed after the band knife treatment (set thickness: 1.15 mm), thicknesses thereof were measured at five spots per each piece (125 spots in total). Then, an average thickness was 1.06 mm, a minimum thickness was 0.80 mm, a maximum thickness was 0.80 mm, σ was equal to 0.093, and the thicknesses did not attain the normal distribution. In a similar way, thicknesses of the half-cut split leather buffed before the band knife treatment were measured. Then, an average thickness was 1.20 mm, a minimum thickness was 1.10 mm, a maximum thickness was 1.30 mm, σ was equal to 0.063, and the thicknesses attained the normal distribution.

The split leather obtained in the pretreatment step is subjected to a softening operation by the vacuum drying/hang drying/milling or the hang drying/milling/toggling and the vibration, whereby the car-seat split crust leather can be obtained.

Moreover, the car-seat split crust leather can be manufactured by a softening operation by milling after the hang drying, and then the toggling and the vibration.

As a result of the treatment described above, the fibers of the split leather, which are thick and stiff, have succeeded in being disentangled by combining the respective drying steps with one another, and further, combining the milling therewith. The drying steps are specified as described above, whereby the fibers of the split leather can be softened at the same time of being disentangled, and the problem that the leather is hard has been able to be solved.

In Patent Literature 10, it is mentioned that natural drying and artificial drying are performed (0076). Then, a description is made of drying means such as the toggle drying, the vacuum drying and the natural drying; however, the combination of the steps of the drying means is not mentioned. Hence, attention is not paid to the solution as intended in the present invention, which is to disentangle the thick and stiff fibers of the split leather by combining the milling with the drying steps. Naturally, this point is not solved. Next, in Patent Literature 10, it is considered possible that the leather can be dried extremely, and it is pointed out that a hardened surface is formed, and that much shrinkage occurs (0078). In consideration of this, it is proposed to give moisture to the split leather, to soften the same, and to form a protective film for preventing contamination thereof, and the split leather is subjected to rolling. In the event of the rolling, the stucco agent is used for sealing (0080). Moreover, it is mentioned that aging is performed for 1 day (0081, 0082), that ironing by rollers is performed (0083, 0084), and that a smooth coating layer is obtained. In accordance with this method, certainly, the smooth surface can be formed, and a hard surface is formed by the ironing; however, it is understood that the problem (3) that the leather is hard and is less likely to be stretched, of which solution is aimed by the inventors of the present invention, cannot be solved.

In the present invention, the car-seat split crust leather is subjected to the drying treatment by being vibrated after being subjected to the vacuum drying/hang drying/milling, or alternatively, the car-seat split crust leather is subjected to the hang drying, the milling, and the toggling, whereby the fibers of the split leather described above can be disentangled, and at the same time, can be turned to a soft state.

A preferable state of the split leather is brought by keeping such a state as described above, and next, the grain side of the split leather is skived by the band knife to thereby set the thickness of the split leather to 1.4 mm to 0.9 mm. Under this state, the final shape of the split leather can be obtained in a state where the fibers of the above-described split leather are disentangled in the soft state.

Moreover, the split leather itself is thick, and accordingly, by thinning the same, the reduction of the weight thereof per unit area can be achieved. At the time of performing the weight reduction, with regard to the split leather, it is necessary to leave and thin the strong portion thereof as an appropriate region. As a result of eliminating the weak portion and leaving the strong portion, the car-seat split crust leather of the present invention can be completed as the split leather in which the strength per unit weight can be increased.

With regard to the car-seat split crust leather in the pretreatment step in the present invention, in consideration that the coating film is to be formed on the surface thereof, the smoothness of the surface skin is not sufficient. Accordingly, the present invention adopts means capable of obtaining the split leather with the smooth surface in such a manner that the stucco agent used as the filler for the leather for the purpose of solving the insufficiency of the smoothness of the surface skin is applied on the surface of the car-seat split crust leather, and that the car-seat split crust leather is further buffed. This means is adopted for the first time by the present invention. Even if the stucco agent is simply applied, the smoothness of the surface cannot be completed.

In the case where the single application of the stucco agent is not sufficient, this operation is performed repeatedly.

The car-seat split crust leather can be obtained, which is characterized in that the split leather with the smooth surface is obtained in such a manner that the surface of the car-seat split crust leather is applied with the stucco agent, and thereafter, is buffed.

The surface of the car-seat split crust leather is applied with the stucco agent, and thereafter, is buffed, whereby the split leather, in which the surface is smooth, can be obtained.

In the case of painting the surface of the car-seat split crust leather by a spray, a roll coater, and the like, unless the surface of the split leather is smooth and the skin surface is fine, the surface absorbs finishing paint, and the skin gets rough. The stucco agent is used to prevent this. An application result of the stucco agent has variations if the application is single, and accordingly, an average result as a whole can be obtained when the application is repeatedly performed twice. In order to measure this result, a 5% ethyl acetate penetration test is performed. A penetration time of ethyl acetate is investigated. A result of the ethyl acetate measurement test when the number of application times of the stucco agent is single was 1 second in a head portion, 5 seconds in a center portion, and 3 seconds in a buttock portion. A result of the ethyl acetate measurement test when the number of application times of the stucco agent is two was 7 seconds in the head portion, 7 seconds in the center portion, and 8 seconds in the buttock portion. When the application of the stucco agent is performed twice, variations in such measurement results are also reduced. It has been found out that, by performing such twice application of the stucco agent and the buffing, the surface skin of the split leather gets uniform, and the penetration of the paint is also uniformed. In the case of performing spray finishing and roll coater finishing for the finishing of the split leather, the twice application of the stucco agent is an important operation.

The car-seat split crust leather is manufactured, which is characterized in that the split leather with the smooth surface is obtained in such a manner that the surface of the car-seat split crust leather is applied with the stucco agent, and thereafter, is buffed.

Moreover, the surface of the car-seat split crust leather is applied with the stucco agent, and thereafter, is buffed, whereby the car-seat split crust leather, in which the surface is smooth, can be manufactured.

In the present invention, the stucco agent is applied on the surface of the car-seat split crust leather, and turns the surface of the car-seat split crust leather into a filled state, and thereafter, the surface concerned is buffed (filed), whereby the surface can be turned to a flat state, and in addition, to a fluffed state.

The stucco agent is aqueous urethane-based resin, and plays a role as filler. The stucco agent penetrates to the surface layer of the leather to fill the gaps among the fibers, and in addition, is fixedly attached to the surface. The surface is smoothed by the subsequent buffing. In the case where the amount of the applied stucco agent is not sufficient, the stucco agent is applied again, and the surface is huffed one more time.

By the stucco agent, the gaps among the leather fibers are filled, and the surface is coated. By the buffing, the protrusions of the surface are shaved off, and the surface becomes flat, and turns to the fluffed state. In the event of forming the coating film, the coating liquid comes to appropriately penetrate, and in addition, the contact area between the coating liquid and the fibers is increased, and accordingly, the adhesive force of the coating film layer onto the leather surface is strengthened. Moreover, since the leather is not pressed, the deterioration thereof in mold fitting can also be avoided.

There does not occur such a problem either that the mold fitting becomes shallow in the embossing (pressing) performed after the color coating layer is formed. Three coating films intimately adhered onto the surface concerned can be formed.

The stucco agent for use is specified.

The above-described stucco agent is a composition composed of: 100 to 150 weight parts of a urethane resin binder; 100 weight parts of a mixture formed of, in a weight ratio of 1:1, silica filler and pigment; and 700 to 800 weight parts of a water-soluble substance.

Stuccoing refers to an operation of coating the “filler” on the tanned leather. The filler for use in stuccoing is the above-described composition.

Marketed products can be purchased and used.

On the surface of the car-seat split crust leather applied with the stucco agent, the stucco agent is applied again, the surface concerned is thereafter buffed, and the coating film is formed on the surface, whereby the car leather is formed.

The car lather is obtained, which is characterized in that a base coat layer containing polyurethane resin, a color coat layer and a top coat layer are provided on the surface of the car-seat split crust leather.

By using coating film forming materials, the coating film is formed on the surface of the car-seat split crust leather applied with the stucco agent, and characteristics such as enhancement of abrasion resistance, strength and a touch feeling are imparted to the surface of the leather, and in addition, an exterior appearance of the surface is enhanced. Specific coating methods are as follows.

### (1) Formation of Base Coat Layer

The base coat layer is formed before the color coat layer and the top coat layer are formed. The base coat layer is a layer for flattening the irregularities present on the surface of the leather, and stably forming layers thereon. Moreover, the base coat layer also has a function to stably fix and bond both of the leather and the layers to each other. Also in the event of forming this layer, the composition composed of resin, pigment, an auxiliary, a tactile agent and a leveling agent and water is coated on the surface of the split leather.

A ratio of the resin as a solid content, the pigment and the auxiliary is 50 to 75:10 to 20:10 to 20 (100% in total, weight ratio). As the resin, two-pack polyurethane resin is used. As the pigment, pigment of a color desired to be colored is used. The auxiliary includes a surfactant, a thickener, an adjustor, a mating agent, and the like. A ratio of the sum of the resin, the pigment, the auxiliary, the tactile agent and the leveling agent and water is 60 to 70:to 40:30 (100% in total, weight ratio). In a state where the composition contains an aqueous solution of the above, as a coating method, there are appropriately selected and used brush coating, spray coating, curtain coating and roll coating. A coating amount of the composition ranges from 55 to 100 g/m². The surface of the split leather is dried by blowing a hot wind thereto after the coating. A film thickness of the composition is 30 to 40 μm.

The surface of the split leather is dried by blowing the hot wind thereto after the coating.

### (2) Formation of Color Coat Layer

The color coat layer is a layer for allowing the existence of the pigment and the dye, which serve for coloring the leather, and is provided on the base coat when viewed from the split leather. Also in the event of forming this layer, the composition composed of the resin, the pigment, the auxiliary, a crosslinking agent, the tactile agent and the leveling agent and water is coated on the surface of the leather.

A ratio of the resin as a solid content, the pigment, the auxiliary, the crosslinking agent, and the sum of the tactile agent and the leveling agent is 50 to 75:10 to 20:0 to 10:3 to 10:1 to 4 (100% in total, weight ratio). As the resin, the two-pack polyurethane resin is used. As the pigment, pigment of a color desired to be colored is used. The auxiliary includes the surfactant, the thickener, the adjustor, and the like. A ratio of the sum of the resin, the pigment, the auxiliary, the tactile agent and the leveling agent and water is 70 to 80:to 30:20 (100% in total, weight ratio). In a state where the composition contains an aqueous solution of the above, as a coating method, there are appropriately selected and used the spray coating, the curtain coating and the roll coating. A coating amount of the composition ranges from 45 to 70 g/m². The surface of the split leather is dried by blowing a hot wind thereto after the coating. A film thickness of the composition is 10 to 15 μm.

### Formation of Top Coat Layer

The top coat layer is a layer, which is formed on a surface of the color coat layer, turns the surface of the coating film into a strong and hard surface, and at the same time, into a state where reflection of light is not much by being added with the matting agent or a flatting agent, and serves for preventing the surface concerned from glittering more than necessary. Also in the event of forming this layer, a ratio of the resin as a solid content, a small amount of the pigment, the crosslinking agent, and the sum of the tactile agent and the leveling agent is 45 to 55:0.1 to 3.0:30 to 40:8 to 15 (100% in total, weight ratio). As the resin, the two-pack polyurethane resin is used. The auxiliary includes the surfactant, the thickener, the adjustor, and the like. A ratio of the sum of the resin, the pigment, the auxiliary, the crosslinking agent, the tactile agent and the leveling agent and water is 75 to 90:to 25:10 (100% in total, weight ratio). In a state where the composition contains an aqueous solution of the above, as a coating method, there are appropriately selected and used the spray coating, the curtain coating and the roll coating. A coating amount of the composition ranges from 30 to 45 g/m². The surface of the split leather is dried by blowing a hot wind thereto after the coating.

The top coat layer is coated twice. A total coating amount becomes 60 to 90 g/cm². Between the first coating and the second coating, drying treatment is performed. A film thickness of the top coat layer becomes 10 to 15 μm.

As the above-described two-pack polyurethane, publicly known two-pack polyurethane resin, in which a polyol component and an isocyanate component are mixed with each other for use, is used. In recent years, in consideration of such a point of an environmental problem owing to a solvent, aqueous two-pack polyurethane resin has been employed. In order to allow the coating film to sufficiently exert the performance thereof, development of a coating layer in which a variety of additives are added to the two-pack polyurethane resin has been advanced.

Also in the event of forming the coating film, three-stage treatment including base coating, intermediate coating and final coating is performed, and among them, by the top coat layer formed by the final coating, the abrasion resistance and the softness have been imparted to the leather, and in addition, color and feeling, which are intrinsic to the leather, have been imparted thereto in response to needs (for example, Japanese Patent No. 3725569, Japanese Patent Laid-Open Publication No. H08-67900 (published in 1998), Japanese Patent Laid-Open Publication No. 2005-330358, Japanese Patent Laid-Open Publication No. 2004-18779, and the like).

In the present invention, the car-seat split crust leather on which the stucco agent is coated is formed by accumulating such partial steps, and the car leather is manufactured by perform the coating on the surface thereof.

A description of a series of the accumulated steps is as follows.

Car-seat leather, characterized in that a hide already subjected to pretreatment and subjected to tanning treatment by using a chromium compound as a tanning agent is split, by using a band knife machine, into leather including a grain surface and into split leather with a thickness of 4 mm or less and exceeding 2.3 mm, the taken-out split leather is arranged so that a flesh side of the split leather can be located on an upper side and that a grain side of the split leather can be located on a lower side, at first, a surface on the grain side is sliced by a band knife to make split leather with a thickness of 2.6 mm to 1.8 mm, next, the flesh side of the split leather is shaved by a shaving machine to thereby set the thickness of the split leather to 2.0 mm to 1.1 mm, subsequently, the grain side is shaved by the shaving machine, to thereby obtain split leather with a thickness of 1.6 mm to 1.0 mm, the split leather is subjected to re-tanning by using a tanning agent made of vegetable tannin and synthetic tannin, followed by dyeing and oiling, and is thereafter subjected to drying treatment of performing vibration after performing vacuum drying/hang drying/milling, or of performing the hang drying, the milling, toggling and the vibration, the grain side is skived by the band knife to set the thickness of the split leather to 1.4 mm to 0.9 mm, a surface of the skived leather split is applied with a stucco agent, and is buffed, whereby split leather with a smooth surface is obtained, and a base coat layer (film thickness: 30 to 40 μm) containing polyurethane resin, a color coat layer (film thickness: 10 to 15 μm) and a top coat layer (film thickness: 10 to 15 μm) are provided on the surface.

A method for manufacturing car-seat leather, characterized in that a hide already subjected to pretreatment and subjected to tanning treatment by using a chromium compound as a tanning agent is split, by using a band knife machine, into leather including a grain surface and into split leather with a thickness of 4 mm or less and exceeding 2.3 mm, the taken-out split leather is arranged so that a flesh side of the split leather can be located on an upper side and that a grain side of the split leather can be located on a lower side, at first, a surface on the grain side is sliced by a band knife to make split leather with a thickness of 2.6 mm to 1.8 mm, next, the flesh side of the split leather is shaved by a shaving machine to thereby set the thickness of the split leather to 2.0 mm to 1.1 mm, subsequently, the grain side is shaved by the shaving machine, to thereby obtain split leather with a thickness of 1.6 mm to 1.0 mm, the split leather is subjected to re-tanning by using a tanning agent made of vegetable tannin and synthetic tannin, subsequently subjected to drying treatment of performing vibration after performing vacuum drying/hang drying/milling, or of performing the hang drying, the milling, toggling and the vibration, the grain side is skived by the band knife to set the thickness of the split leather to 1.4 mm to 0.9 mm, a surface of the skived leather split is applied with a stucco agent, and is buffed, whereby split leather with a smooth surface is obtained, and a base coat layer (film thickness: 30 to 40 μm) containing polyurethane resin, a color coat layer (film thickness: 10 to 15 μm) and a top coat layer (film thickness: 10 to 15 μm) are provided on the surface.

When the shape of the above-described car-seat leather is described as a generally measurable range, the above-described car-seat leather is as follows.

Car leather, characterized in that a thickness of a whole of the car leather, in which a coating film composed of a base coat layer containing polyurethane resin, a color coat layer and a top coat layer is formed on a surface of a car-seat split crust leather in which a thickness is 0.9 to 1.4 mm and a surface is applied with a stucco agent and smoothed, is 0.9 to 1.5 mm.

Characteristics of examples and a comparative example of the car leather of the present invention are as follows.

TABLE 1

| Test Item | Present Invention | Comparative example |
|---|---|---|
| Test piece | according to those of | according to that of |
| | Example 1 to Example 8 | comparative example |
| Tensile strength | 301N | 121N |
| Tearing strength | 42N | 13N |
| Abrasion resistance | class 5 (no problem) | class 5 (no problem) |
| Load elongation | 9.50% | 9.60% |
| Bending resistance | 88 mm | 84 mm |
| (by cantilever | | |
| tester) | | |
| Car seat fitting test | no problem | cannot be implemented |

### Example 1

Pretreatment

A cowhide in a state of being left stripped from an animal was salt-cured.

This was taken out, and was treated by preservative.

A subcutaneous tissue, a lump of flesh, fat and the like were attached onto an inner surface of such a raw hide. In order to remove these, fleshing was performed by using a fleshing machine.

The raw hide, which was added with water, and was allowed to absorb water and was softened, was immersed into lime milk, and a surface skin tissue thereof was dissolved and removed.

The hide was subjected to neutralization by deliming, and was added with water, calcium hydroxide was eluted therefrom by shrinkage, and the hide was subjected to bating treatment of performing enzyme treatment, and thereafter was subjected to pickling treatment by acid.

### Example 2

Tanning Step

Tanning was performed in a state where, with respect to 160 kg of a leather weight, 38.8 kg of a trivalent chromium complex Cr₂(SO₄) as a tanning agent and 0.6 kg of bicarbonate was added to 156 kg of water. A treatment temperature was 38° C., pH was 3.5, and a treatment time was 12 hours.

### Example 3

By using the band knife machine, the leather thus obtained was sliced into leather including a grain surface and split leather with a thickness of 2.6 mm, and the split leather was taken out. The split leather was arranged so that a flesh side thereof could be located on an upper side and that a grain side thereof could be located on a lower side. At first, a surface on the grain side was sliced by the band knife to obtain split leather with a thickness of 2.5±0.3 mm. Next, a flesh side of the split leather is shaved by the shaving machine to thereby set the thickness of the split leather to 1.5±0.3 mm, and further, the grain side thereof was shaved by the shaving machine, whereby split leather with a thickness of 1.3±0.3 mm was obtained (±0.3 mm is a range of a tolerance of the band knife machine and the shaving machine.).

### Example 4

Regarding Re-Tanning, Drying Step and Oiling Step

The split leather was subjected to washing by water washing, and to neutralization treatment by water containing sodium formate.

The re-tanning was performed by using, as a re-tanning agent, 2.0 kg of the vegetable tannin and 1.5 kg of the synthetic tannin, and by adding the re-tanning agent to 20 kg of water.

At the same time, 0.8 kg of acid dye was added to a resultant. A treatment temperature was 30° C.

Fixing treatment was performed by performing treatment by water added with formic acid.

3 kg of an anionic oiling agent (sulfonated oil, sulfonation oil) was added to 90 kg of water, and an oiling operation was performed at 60° C. A treatment time was 1 hour. After the end of the treatment, formic acid was added to the resultant, and the tanning agent was fixed. Thereafter, the split leather was water-washed.

### Example 5

Drying Step in Finishing Step

The following two methods were performed.

(1) The vibration was performed after performing the vacuum drying/hang drying/milling.
(2) The hang drying/milling/toggling/vibration were performed.

Note that the drying treatment was performed before the milling. The inventors of the present invention performed the milling and the vibration after performing the vacuum drying/hang drying as the drying treatment, or alternatively, performed the milling after the hang drying, and then performed toggling and the vibration, whereby the inventors of the present invention succeeded in disentangling the thick and stiff fibers, which compose the split leather, by combining the milling with the drying step. After the drying treatment performed by the drying, the milling, the toggling and the vibration, the flesh side of the split leather was buffed (filed), and subsequently, the grain side of the split leather was shaved by the band knife to set the thickness thereof at 1.4 to 0.9 mm, whereby the target thickness of the split leather, which is not thick, can be decided.

### Example 6

For each of the above-described finishing steps, the following final thickness adjustment step was performed.

The grain side was split by the band knife (made by Linter Corporation), and the thickness of the split leather was adjusted to 1.1 mm.

FIG. 2 shows a cross-sectional photograph.

This is a cross-sectional photograph of the split leather at a stage before applying the stucco onto the surface thereof. It is understood that the irregularities of the surface are intense, and that the leather fibers protrude and are fluffed remarkably. It is understood that he surface is not flat.

### Example 7

Regarding Formation of Smooth Surface

The dried split leather was buffed.

The surface of the split leather was applied with the stucco agent, and was subjected to the drying treatment.

Thereafter, the split leather was buffed (filed). The surface of the split leather was applied with the stucco agent one more time, and was subjected to the drying treatment. Thereafter, the split leather was buffed (filed).

As coating means, the roll coating was employed. A coating amount was 50 g/m², and the film thickness was 4 to 6 μm.

In the above-described stucco agent, the urethane resin binder was 100 to 150 weight parts, the mixture composed of the silica filler and the pigment in a ratio of 1:1 was 100 weight parts, and the aqueous substance was 700 to 800 weight parts.

FIG. 3 shows a cross-sectional photograph.

FIG. 3 is the split leather in which the surface was applied with the stucco, and was buffed after being dried. The gaps among the leather fibers in the surface layer are filled with the stucco (portions looking white in the photograph), and on the surface, a thin layer of the stucco is formed. The surface becomes smooth, and the irregularities and the fluffs are hardly seen.

### Example 8

### (1) Formation of Base Coat Layer

A ratio of the resin as the solid content, the pigment and the auxiliary is 50 to 75:10 to 20:10 to 20 (100% in total, weight ratio). As the resin, the two-pack polyurethane resin is used. As the pigment, pigment mainly containing a black component was used. The auxiliary includes the surfactant, the thickener, the adjustor, the mating agent, and the like.

A ratio of the sum of the resin, the pigment, the auxiliary, the tactile agent and the leveling agent and water is 60 to 70:40 to 30 (100% in total, weight ratio).

As the coating method, the spray coating was used in a state where the composition contained the aqueous solution. The coating amount was 100 g/m², and the surface of the split leather was dried by blowing a hot wind thereto after the coating. The film thickness of the composition was 34 μm.

### Example 9

### (2) Formation of Color Coat Layer

A ratio of the resin as the solid content, the pigment, the auxiliary, the crosslinking agent, the tactile agent and the leveling agent is 50 to 75:10 to 20:0 to 10:3 to 10:1 to 4 (100% in total, weight ratio). As the resin, the two-pack polyurethane resin was used. As the pigment, mainly black pigment was used. The auxiliary includes the surfactant, the thickener, the adjustor, and the like. A ratio of the sum of the resin, the pigment, the auxiliary, the tactile agent and the leveling agent and water is 70 to 80:30 to 20 (100% in total, weight ratio).

As the coating method, the spray coating was used in a state where the composition contained the aqueous solution. The coating amount was 70 g/m², and the surface of the split leather was dried by blowing a hot wind thereto after the coating. The film thickness of the composition was 10 μm.

After the color coat layer was formed, embossing (press) was performed.

### (3) Formation of Top Coat Layer

Also in the event of forming this layer, a ratio of the resin as the solid content, a small amount of the pigment, the crosslinking agent, and the sum of the tactile agent and the leveling agent was 45 to 55:0.1 to 3.0:30 to 40:8 to 15 (100% in total, weight ratio). As the resin, the two-pack polyurethane resin is used. The auxiliary includes the surfactant, the thickener, the adjustor, and the like. A ratio of the sum of the resin, the pigment, the auxiliary, the crosslinking agent, the tactile agent and the leveling agent and water was 75 to 90:25 to 10 (100% in total, weight ratio).

As the coating method, the spray coating was used in a state where the composition contained the aqueous solution. The coating amount was 45 g/m², and the surface of the split leather was dried by blowing a hot wind thereto after the coating. The coating was performed twice. The total coating amount was 90 g/m².

The film thickness of the composition is 13

FIG. 4 shows a cross-sectional photograph.

FIG. 4 is a cross-sectional photograph of the split leather, which was subjected to the stuccoing/buffing treatment, and thereafter, had the three-layer coating film formed thereon. On the thin layer of the stucco, the coating film was intimately adhered in a favorable manner.

The thickness of the car leather (Example 9) was measured, in which the coating film composed of the base coat layer containing the polyurethane resin, the color coat layer and the top coat layer was formed on the surface of the car-seat split crust leather having the thickness of 1.1 mm and having the surface smoothed by being applied with the stucco agent. Then, the measured thickness was 1.1 mm.

Other physical characters of the split leather were as follows, and the split lather was sufficiently usable for the car seat. Moreover, the split leather was able to be fitted to a seat mount without any problem.

As opposed to this, with regard to split leather (Comparative example 1) prepared in a similar way to Examples 1 to 8 except that the flesh side was split in the final thickness adjustment step, tensile strength/tearing strength thereof were remarkably weak, and it was difficult to use this split leather as the car-seat leather.

### (1) The Thickness was Measured in the Following Manner.

In accordance with JIS K 6550, the thickness was measured by using a dial gauge (in conformity with JIS K 7503) made by Tester Sangyo Co., Ltd.). A diameter of a pressurization surface was 10 mm, and a load was set at 390 g.

### (2) Tensile Strength

Test pieces with a width of 30 mm and a length of 150 mm were pulled at a speed of 200 mm/min by using the tensilon-type tensile tester (Shimadzu AG-1, made by Shimadzu Corporation), and strength of each test piece at the time of fracture was measured.

Measurement results of the tensile strength are as follows. It was exhibited that strong tensile strength was obtained by splitting the grain side in the final thickness adjustment step.

Split leather in which the grain side was split (Example 8): 301 N

Split leather in which the flesh side was split (Comparative example 1): 121 N

### (3) Tearing Strength

Into each of test pieces with a width of 30 mm and a length of 150 mm, a slit with a length of 50 mm was cut from one end thereof along a centerline thereof, end portions cut into two were grasped and pulled in opposite directions, and strength when the test piece was torn was measured. The tensilon-type tensile tester (Shimadzu AG-1, made by Shimadzu Corporation) was used, and a pulling speed was set at 200 mm/min.

Measurement results of the tearing strength are as follows. It was exhibited that strong tearing strength was obtained by splitting the grain side in the final thickness adjustment step.

Split leather in which the grain side was split (Example 8): 42 N

Split leather in which the flesh side was split (Comparative example 1): 13 N

### (4) Abrasion Resistance

By using a taper-type abrasion tester (abrasion ring CS-10), for each of test pieces, an abrasion operation was performed 4000 times with a load of 9.8 N at a revolution speed of 60 rpm. Thereafter, surface discoloration/coating film peeling were visually observed, and were determined based on the following criteria.

Class 1: considerably remarkable

Class 2: somewhat remarkable

Class 3: apparently recognized; however, less conspicuous

Class 4: slightly recognized; however, hardly conspicuous

Class 5: not recognized at all

A determination result of the split leather of Example 8 was Class 5, and it was exhibited that the split leather had sufficient abrasion resistance as the leather for the car seat.

### (5) Constant Load Elongation

Test pieces with a width of 30 mm and a length of 150 mm were pulled at a speed of 200 mm/min by using the tensilon-type tensile tester (Shimadzu AG-1, made by Shimadzu Corporation), and elongation of each thereof when the load was 30 N was measured.

A measurement value of the split leather of Example 8 is 9.5%, and sufficient stretch for fitting the leather to the car seat was exhibited.

### (6) Bending Resistance

Measurement was performed by using a cantilever bending resistance tester.

A test piece 1 with a width of 25 mm and a length of 200 mm was set while a short side thereof was being matched with a scale base line 2 (a boundary line between a planer surface and a 45-degree inclined surface) of the cantilever bending resistance tester, the test piece 1 was slid at a speed of 10 mm/min in a direction of the 45-degree inclined surface 3, and a moving distance of other end of the test piece 1 when the one end of the test piece 1 located at a position of the scale base line was brought into contact with the 45-degree inclined surface was measured. The measured moving distance was defined as bending resistance.

A measurement value of the split leather of Example 8 is 88 mm, and the split leather had softness suitable as the leather for the car seat.

### (7) Car Seat Fitting Test

A test of fitting the split leather of Example 8 to the car seat was conducted. The split leather was cut to prepare parts for sewing. Thereafter, the parts were sewed to make a bag-like cover matched with the shape of the car seat, and the car seat was covered with the cover. At this time, if the stretch of the leather is insufficient, and the leather is too hard, such an operation of covering the car seat with the cover becomes extremely difficult.

In the split leather of Example 8, sufficient stretch and softness were obtained, and the split leather was able to be fitted without any problem.

### INDUSTRIAL APPLICABILITY

In accordance with the present invention, as a result of improving the characteristics of the split leather, it becomes possible to use the split lather in various fields.

1. A car-seat split crust leather, wherein a hide already subjected to pretreatment and subjected to tanning treatment by using a chromium compound as a tanning agent is split, by using a band knife machine, into leather including a grain surface and into split leather with a thickness of 4 mm to 2.3 mm, the taken-out split leather is arranged so that a flesh side of the split leather can be located on an upper side and that a grain side of the split leather can be located on a lower side, at first, a surface on the grain side is sliced by a band knife to make split leather with a thickness of 2.6 mm to 1.8 mm, next, the flesh side of the split leather is shaved by a shaving machine to thereby set the thickness of the split leather to 2.0 mm to 1.1 mm, and subsequently, the grain side is shaved by the shaving machine to thereby obtain split leather with a thickness of 1.6 mm to 1.0 mm.

2. A car-seat split crust leather, wherein the car-seat split crust leather is obtained in such a manner that the car-seat split crust leather according to claim 1 is subjected to re-tanning by using a re-tanning agent composed of vegetable tannin and synthetic tannin, followed by dyeing and oiling.

3. A car-seat split crust leather, wherein the car-seat split crust leather according to claim 2 is subjected to drying treatment by performing vibration after performing vacuum drying/hang drying/milling, thereafter, the flesh side of the split leather is buffed (filed), and subsequently, the grain side of the split leather is shaved by the band knife to set the thickness of the split leather to 1.4 mm to 0.9 mm.

4. A car-seat split crust leather, wherein the car-seat split crust leather according to claim 2 is subjected to drying treatment by performing hang drying, milling, toggling and vibration, thereafter, the flesh side of the split leather is buffed (filed), and subsequently, the grain side of the split leather is shaved by the band knife to set the thickness of the split leather to 1.4 mm to 0.9 mm.

5. A car-seat split crust leather, wherein a stucco agent is applied on a surface of the car-seat split crust leather according to claim 3, thereafter, the surface is buffed, and split leather with a smooth surface is formed.

6. A car-seat split crust leather, wherein the stucco agent is applied again on the surface of the car-seat split crust leather according to claim 5, thereafter, the surface is buffed, and split leather with a smooth surface is formed.

7. The car-seat split crust leather according to claim 5, wherein the stucco agent is composed of: 100 to 150 weight parts of a urethane resin binder; 100 weight parts of a mixture formed of silica filler and pigment in a weight ratio of 1:1; and 700 to 800 weight parts of a water-soluble substance.

8. Car-seat leather, wherein a base coat layer containing polyurethane resin, a color coat layer and a top coat layer are provided on the surface of the car-seat split crust leather according to claim 5.

9. Car-seat leather, wherein a hide already subjected to pretreatment and subjected to tanning treatment by using a chromium compound as a tanning agent is split, by using a band knife machine, into leather including a grain surface and into split leather with a thickness of 4 mm to 2.3 mm, the taken-out split leather is arranged so that a flesh side of the split leather can be located on an upper side and that a grain side of the split leather can be located on a lower side, at first, a surface on the grain side is sliced by a band knife to make split leather with a thickness of 2.6 mm to 1.8 mm, next, the flesh side of the split leather is shaved by a shaving machine to thereby set the thickness of the split leather to 2.0 mm to 1.1 mm, subsequently, the grain side is shaved by the shaving machine to thereby obtain split leather with a thickness of 1.6 mm to 1.0 mm, the split leather is subjected to re-tanning by using a re-tanning agent made of vegetable tannin and synthetic tannin, followed by dyeing and oiling, and is thereafter subjected to drying treatment of performing vibration after performing vacuum drying/hang drying/milling, or of performing the hang drying, the milling, toggling and the vibration, the grain side of the split leather is buffed (filed), the grain side is skived by the band knife to set the thickness of the split leather to 1.4 mm to 0.9 mm, a surface of the skived leather split is applied with a stucco agent, and is buffed, whereby split leather with a smooth surface is obtained, and a base coat layer (film thickness: 30 to 40 μm) containing polyurethane resin, a color coat layer (film thickness: 10 to 15 μm) and a top coat layer (film thickness: 10 to 15 μm) are provided on the surface.

10. Car-seat leather, wherein a thickness of a whole of the car leather, in which a coating film composed of a base coat layer containing polyurethane resin, a color coat layer and a top coat layer is formed on a surface of a car-seat split crust leather in which a thickness is 0.9 to 1.4 mm and a surface is applied with a stucco agent and smoothed, is 0.9 to 1.5 mm.

11. A method for manufacturing a car-seat split crust leather, wherein a hide already subjected to pretreatment and subjected to tanning treatment by using a chromium compound as a tanning agent is split, by using a band knife machine, into leather including a grain surface and into split leather with a thickness of 4 mm or less and exceeding 2.3 mm, the taken-out split leather is arranged so that a flesh side of the split leather can be located on an upper side and that a grain side of the split leather can be located on a lower side, at first, a surface on the grain side is sliced by a band knife to make split leather with a thickness of 2.6 mm to 1.8 mm, next, the flesh side of the split leather is shaved by a shaving machine to thereby set the thickness of the split leather to 2.0 mm to 1.1 mm, and subsequently, the grain side is shaved by the shaving machine to thereby obtain split leather with a thickness of 1.6 mm to 1.0 mm.

12. A method for manufacturing a car-seat split crust leather, wherein the car-seat split crust leather according to claim 1 is subjected to re-tanning by using a re-tanning agent composed of vegetable tannin and synthetic tannin, followed by dyeing and oiling.

13. A method for manufacturing a car-seat split crust leather, wherein the car-seat split crust leather according to claim 2 is subjected to drying treatment by performing vibration after performing vacuum drying/hang drying/milling, thereafter, the flesh side of the split leather is buffed (filed), and subsequently, the grain side of the split leather is shaved by the band knife to set the thickness of the split leather to 1.4 mm to 0.9 mm, whereby a thickness of the split leather, which is not thick, can be decided.

14. A method for manufacturing a car-seat split crust leather, wherein the car-seat split crust leather according to claim 2 is subjected to drying treatment by performing hang drying, milling, toggling and vibration, thereafter, the flesh side of the split leather is buffed (filed), and subsequently, the grain side of the split leather is shaved by the band knife to set the thickness of the split leather to 1.4 mm to 0.9 mm, whereby a thickness of the split leather, which is not thick, can be decided.

15. A method for manufacturing a car-seat split crust leather, wherein a stucco agent is applied on a surface of the car-seat split crust leather according to claim 3, thereafter, the surface is buffed, and split leather with a smooth surface is formed.

16. A method for manufacturing a car-seat split crust leather, wherein the stucco agent is applied again on the surface of the car-seat split crust leather according to claim 5, thereafter, the surface is buffed, and split leather with a smooth surface is formed.

17. The method for manufacturing a car-seat split crust leather according to claim 15, wherein the stucco agent is composed of: 100 to 150 weight parts of a urethane resin binder; 100 weight parts of a mixture formed of silica filler and pigment in a weight ratio of 1:1; and 700 to 800 weight parts of a water-soluble substance.

18. A method for manufacturing a car-seat leather, wherein a base coat layer containing polyurethane resin, a color coat layer and a top coat layer are provided on the surface of the car-seat split crust leather according to claim 5.

19. A method for manufacturing car-seat leather, wherein a hide already subjected to pretreatment and subjected to tanning treatment by using a chromium compound as a tanning agent is split, by using a band knife machine, into leather including a grain surface and into split leather with a thickness of 4 mm or less and exceeding 2.3 mm, the taken-out split leather is arranged so that a flesh side of the split leather can be located on an upper side and that a grain side of the split leather can be located on a lower side, at first, a surface on the grain side is sliced by a band knife to make split leather with a thickness of 2.6 mm to 1.8 mm, next, the flesh side of the split leather is shaved by a shaving machine to thereby set the thickness of the split leather to 2.0 mm to 1.1 mm, subsequently, the grain side is shaved by the shaving machine to thereby obtain split leather with a thickness of 1.6 mm to 1.0 mm, the split leather is subjected to re-tanning by using a re-tanning agent made of vegetable tannin and synthetic tannin, followed by dyeing and oiling, and is thereafter subjected to drying treatment of performing vibration after performing vacuum drying/hang drying/milling, or of performing the hang drying, the milling, toggling and the vibration, the grain side of the split leather is thereafter buffed (filed), the grain side is skived by the band knife to set the thickness of the split leather to 1.4 mm to 0.9 mm, a surface of the skived leather split is applied with a stucco agent, and is buffed, whereby split leather with a smooth surface is obtained, and a base coat layer (film thickness: 30 to 40 μm) containing polyurethane resin, a color coat layer (film thickness: 10 to 15 μm) and a top coat layer (film thickness: 10 to 15 μm) are provided on the surface.

20. A car-seat split crust leather, wherein a stucco agent is applied on a surface of the car-seat split crust leather according to claim 4, thereafter, the surface is buffed, and split leather with a smooth surface is formed.

21. The car-seat split crust leather according to claim 6, wherein the stucco agent is composed of: 100 to 150 weight parts of a urethane resin binder; 100 weight parts of a mixture formed of silica filler and pigment in a weight ratio of 1:1; and 700 to 800 weight parts of a water-soluble substance.

22. Car-seat leather, wherein a base coat layer containing polyurethane resin, a color coat layer and a top coat layer are provided on the surface of the car-seat split crust leather according to claim 6.

23. A method for manufacturing a car-seat leather, wherein a base coat layer containing polyurethane resin, a color coat layer and a top coat layer are provided on the surface of the car-seat split crust leather according to claim 6.

24. A method for manufacturing a car-seat split crust leather, wherein a stucco agent is applied on a surface of the car-seat split crust leather according to claim 4, thereafter, the surface is buffed, and split leather with a smooth surface is formed.

25. The method for manufacturing a car-seat split crust leather according to claim 16, wherein the stucco agent is composed of: 100 to 150 weight parts of a urethane resin binder; 100 weight parts of a mixture formed of silica filler and pigment in a weight ratio of 1:1; and 700 to 800 weight parts of a water-soluble substance.
